(19) United States
(12) Patent Application Publication
(10) Pub. No.: US 2024/0356769 A1
(43) Pub. Date: Oct. 24, 2024

(54) CONSENSUS METHOD FOR BLOCKCHAIN

(71) Applicant: TERRADOXA SAS, Courbevoie (FR)

(72) Inventors: Emmanuel PESENTI, Courbevoie (FR); Abdeslam JAKJOUD, Courbevoie (FR)

(21) Appl. No.: 18/685,896

(22) PCT Filed: Aug. 26, 2021
(86) PCT No.: PCT/EP2021/073692

§ 371 Date: Feb. 22, 2024

(51) Int. Cl. H04L 9/00; H04L 9/08; H04L 9/14; H04L 9/32

(52) U.S. Cl. CPC H04L 9/50; H04L 9/0869; H04L 9/14; H04L 9/3236

(57) ABSTRACT

A blockchain includes a distributed network with multiple nodes including an administrative node, ‘AN’, one elected node, ‘EN’, and regular nodes, ‘RN’, each of the AN, EN and RN having a virtual machine, ‘VM’, a checker service running on the VM and a checker account available to other nodes with reading and/or executing rights on the checker service; and provider nodes, ‘PN’, providing transactions to the blockchain. A method includes (i) electing, by the AN, the EN amongst the plurality of RN; (ii) receiving, by the EN, transactions from PN; (iii) running the checker service of the EN through its checking account for each received transaction; (iv) generating, by the EN, a block containing the checked transactions; (v) sending, by the EN, the generated block to the plurality of RN; and (vi) running the checker service of the EN through its checking account for the generated block to authenticate it.

### TECHNICAL FIELD

The present disclosure relates to the field of blockchain technology, and in particular to a blockchain consensus method.

The invention more particularly relates to the application of such blockchain consensus method to identity management through a distributed ledger technology.

### BACKGROUND

Blockchain technology, also referred to as a distributed ledger technology, is an emerging technology that several computing devices participate in keeping “ledger” to jointly maintain a complete distributed database. The blockchain technology is characterized by decentralization, openness, and transparency, and also, in the blockchain technology, each computing device can participate in database recording, and data can be synchronized rapidly between the computing devices. Therefore, the blockchain technology has been widely applied to many fields.

An “Analysis of the main consensus protocols of blockchain” is given in the article of Shijie Zhang et al. available online on 12 Aug. 2019. In this article, the most common consensuses are presented such as PoW (Proof of Work) based on computational power and PoS (Proof of Stake) based on the held stake.

Each existing consensus presents some limitation. PoW consumes the most computational power, and the transaction throughput per second, which greatly limits the application prospect of PoW. PoS have similar shortcomings, although they can greatly reduce the consumption of the computational power but on the other hand cannot structurally offer the same level of security as a PoW because it does not require computational work in return for its validations.

Further, PoS protocols can suffer from the nothing-at-stake problem, where validator nodes validate conflicting copies of the blockchain because there is minimal cost to doing so, and a smaller chance of losing out on rewards by validating a block on the wrong chain.

The present disclosure improves the situation over the prior art. In particular, the purpose of the present disclosure is to ensure high security and authentication of the transactions recorded in the distributed blocks while assuring that all nodes hold the same content, as do the usual blockchain systems, without having high energy consumed by the system and avoiding nothing-at-stake problem.

### SUMMARY

A first aspect of the present disclosure concerns a method for consensus in a blockchain including a distributed network with multiple nodes among which one administrative node, ‘AN’, one elected node, ‘EN’, and a plurality of regular nodes, ‘RN’, each of the AN, EN and RN having a virtual machine, ‘VM’, a checker service running on the VM and a checker account available to other nodes with reading and/or executing rights on the checker service; and provider nodes, ‘PN’, providing transactions to the blockchain, the method including the steps of:
electing, by the AN, the EN among the plurality of RN;
receiving, by the EN, transactions from PN;
running the checker service of the EN through its checking account for each received transaction;
generating, by the EN, a block containing the checked transactions;
sending, by the EN, the generated block to the plurality of RN;
running the checker service of the EN through its checking account for the generated block to authenticate it.

Such consensus method requests very little power consumption as there is only one node, i.e. the EN, building a new block at a time while securing a high level of security thanks to the checker service and checker account allowing direct and permanent availability of the EN while forging by any other node. Each transaction is checked as well as the block when generated.

Advantageously, the running step of the checker service for each received transaction is performed either by at least one RN amongst the plurality of RN or any external node, and wherein the running step of the checker service for the generated block is performed by the plurality of RN.

Checking each new transaction by any node gives flexibility and at the same time security while checking the generated block by the plurality of RN provides higher security level before releasing a new block in the blockchain.

Advantageously, each AN, EN, RN node further has predetermined services including the checker service and at least a process check service, all predetermined services running on the VM; and the running step of the checker service comprises the sub-steps of:

running the process checker service to retrieve a list of running services on the VM; and
validating the running services when the list of running services and the list of the predetermined services concur.

Such process checker service strengthens the running step by ensuring that all running services on the VM are only the predetermined ones and therefore preventing unknown services to be running on the VM.

Advantageously, each AN, EN, RN node has one or more local executable files of the predetermined services which further includes a hash service, and wherein the running step of the checker service further comprises the sub-steps of:
downloading a trusted source codes of the predetermined services stored in a trusted blockchain repository;
compiling trusted source codes to obtain one or more trusted executable files; and
hashing, by the hash service, the one or more trusted executable files to obtain at least one trusted hash value;
hashing, by the hash service, the one or more local executable files to obtain at least one local hash value; and
validating the one or more local executable files when the one or more local hash value and the one or more trusted hash value concur; or
sending to the AN, an EN compromised, ‘ENC’, signal when the one or more local hash value and the one or more trusted hash value do not concur.

Such hash service further strengthens the security of the running step by ensuring that all running services on the VM uses the latest available versions of the source codes for each predetermined service, so that it does not contain any corrupted code.

Advantageously, the predetermined services further includes an extractor service, and wherein, when the AN receives an ENC signal, the running step further includes the sub-steps of:
using, by the AN, the checker service of the EN to confirm the ENC signal; and in case of a confirmed ENC signal:
   using, by the AN, the extractor service of the compromised EN to retrieve checked transactions;
   disconnecting the compromised EN from the distributed network; and
   launching a new electing step.

Such extractor service further strengthens the security of the running step by isolating a compromised node and retrieving transactions before its compromission.

Advantageously, the detection of the predetermined condition of the generating step occurs:
when a predetermined number of transactions have been checked; or
when a predetermined interval of time has elapsed since the electing step.

Such predetermined condition prevents a generating step lasting too long either in terms of the number of transactions contained in the generated block or the time between the generation of two consecutive blocks, and therefore reduces the frame for attacking the EN.

Advantageously, after authentication of the generated block, the method further comprises the step of designating the EN as the new AN before looping to a new electing step.

Designating the EN as the new AN for the next block generation prevents the EN to be elected twice in a row, therefore further reducing the risks of external control of the EN.

Advantageously, a running step of the checker service is further executed at regular time intervals.

Introducing a regular check of the checker service further narrows the frame for an attack against the EN.

Advantageously, a running step of the checker service is further executed just after the electing step by the AN to check that the EN is not corrupted.

Such initial check of the checker service just after the election ensures that the EN is safe from the beginning of the running step.

Advantageously, the AN processes a new electing step whenever the EN is no longer available in the distributed network.

In the event that the EN disappears from the distributed network (e.g. lack of connection), the AN will process a new election to prevent that the disconnected EN suddenly reappears to perform a block generation.

Advantageously, the electing step includes the sub-steps of requesting, by the AN, election information from the plurality of RN; and electing, by the AN, the EN amongst the plurality of RN based on the requested election information. More preferably, the election information includes at least an elected occurrence number, ‘EON’, corresponding to the number of times an RN has already been elected.

Using the EON has a criteria in the election process will ensure that an RN that has been often elected gets a lower chance to be the next EN versus another RN with a lower EON. Other criteria can be used such as the reliability of the RN in view of past block generations, its location, its dependency to a larger group of nodes, the amount of transactions performed, etc.

Advantageously, the election step is based on a non-deterministic election algorithm using at least one random number to determine the EN. More preferably, each AN, EN and RN node is identified by a unique identification number, ‘UIN’, its EON and a set of public/private keys and wherein the electing step comprises at least the sub-steps consisting of:
providing, by each RN, its UIN, its EON, its public key to the AN;
ranking, by the AN, the RN by their EON and associating each RN with an interval depending on the EON;
receiving, by the AN, a random number from the previous AN;
computing, by the AN, a function of the UIN and the EON, hashing the computed function result, encrypting the hashed function result with the AN private key, computing a function of the encrypted function result and the provided random number to get a final number;
traversing the RN intervals with this final number and progressively eliminating the corresponding RN it comes across, until only one RN remains which becomes the EN.

Such election process is used to ensure that the next EN cannot be known in advance unlike some crypto currencies using a formula where the stakes of account are public, and where each node can predict with reasonable accuracy which account will win the right to forge an additional block in the blockchain.

Advantageously, the blockchain consensus is a distributed ledger technology, ‘DLT’, containing shared data referred as transactions. More preferably, the shared data are specific ID type data.

Such DLT can be applied to many different fields. One interesting application is identity management where ID type data can be safely stored in the DLT and easily accessed upon authorization.

Advantageously, the specific ID type data is authenticated upon request by a trusted third party via a smart contract.

Another aspect of the present disclosure concerns a blockchain distributed network with multiple nodes comprising: one administrative node, ‘AN’, one elected node, ‘EN’, and a plurality of regular nodes, ‘RN’, each of the AN, EN and RN having a virtual machine, ‘VM’, a checker service running on the VM and a checker account available to other nodes with reading and/or executing rights on the checker service; and provider nodes, ‘PN’, providing transactions to a blockchain of the distributed network; wherein a blockchain consensus method according to the first aspect is applied to the blockchain distributed network.

Another aspect of the present disclosure concerns an electronic device comprising a processor and a memory wherein the memory is used to store the source code of the predetermined services and the processor is configured to host the virtual machine calling the source code stored in the memory to execute the method according to the first aspect.

A computer-readable storage medium wherein instructions are stored in the computer-readable storage medium and when the instructions are run on a computer, the computer executes the method according to the first aspect.

### BRIEF DESCRIPTION OF THE DRAWINGS

Other features, purposes and advantages of the disclosure will become more explicit by means of reading the detailed statement of the non-restrictive embodiments made with reference to the accompanying drawing.

FIG. 1 shows an example of a peer-to-peer network of nodes according to the present disclosure;

FIG. 2A shows an example of architecture of a blockchain node according to the present disclosure;

FIG. 2B shows an example of checker account of a blockchain node according to the present disclosure;

FIG. 3 shows a diagram of a consensus method according to one embodiment of the present disclosure;

FIG. 4 shows a diagram of a consensus method according to another embodiment of the present disclosure;

FIG. 5 shows a diagram in case of a corruption notification emitted during the consensus method;

FIG. 6 shows an example diagram of an election process according to the present disclosure.

### DETAILED DESCRIPTION

The distributed ledger technology, ‘DLT’ or database is spread across several nodes (devices) on a peer-to-peer network, where each replicates and saves an identical copy of the ledger and updates itself independently. The primary advantage is the lack of central authority.

A consensus mechanism refers to any number of methodologies used to achieve agreement, trust, and security across such decentralized computer; i.e. peer-to-peer network.

The present disclosure describes a blockchain identity management system, dealing with “identity” type transactions, having roles attribution processes to the nodes of the blockchain to limit the energy consumption when building blocks and a specific software process to guaranty the authentication and securing of the distributed data. Of course other type of transactions are also possible with this blockchain management system and specific software process.

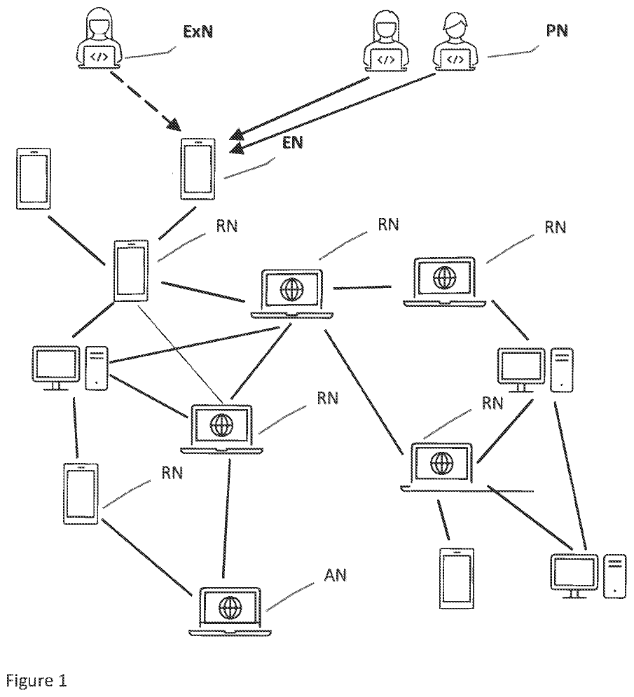

FIG. 1 shows an example of a peer-to-peer network of nodes according to the present disclosure. The network constituting the identity management system includes three kinds of nodes: one Administrator Node, ‘AN’, one Elected Node, ‘EN’, and a plurality of Regular Nodes, ‘RN’. Each kind of node has its own role which will be briefly summarized below.

The AN (only one node in the network) requires information from RN to elect one of them to be the (only one) EN via a specific election process.

The EN, once elected, will receive new transactions from providers, or provider nodes, ‘PN’. A checking process occurs on the EN to validate each received transaction. The EN then adds the received transactions to a new block under construction. By doing so, the EN gathers the incoming transactions either up to the completion of the new block, e.g. defined by a number of received transactions, or until a predetermined time has elapsed since its election. For example, a variable time interval will be set between 15 and 60 minutes depending on the traffic volume on the network. 15 minutes will be chosen for a higher traffic and 60 minutes for a lower traffic. Once the new block is completed, the EN sends the generated block to all other RN for authentication purposes. The EN becomes the AN after generating the new block and start organizing the next election as the new AN.

The RN are all the nodes part of the peer-to-peer network which are neither the AN nor the EN. All of them can become the EN if they are elected and then the AN after they completed a block generation. Each RN present in the network provides election information to the AN before an election process so as to be potentially elected. These RN are also used to check each new transaction as well as to authenticate a newly generated block.

PN are not directly part of the peer-to-peer network. They only provide new transactions to the EN. External node(s), ‘ExN’, are nodes which are not regular nodes but can be used to perform the running step of the checker service of the EN at any time and in particular for each newly received transaction.

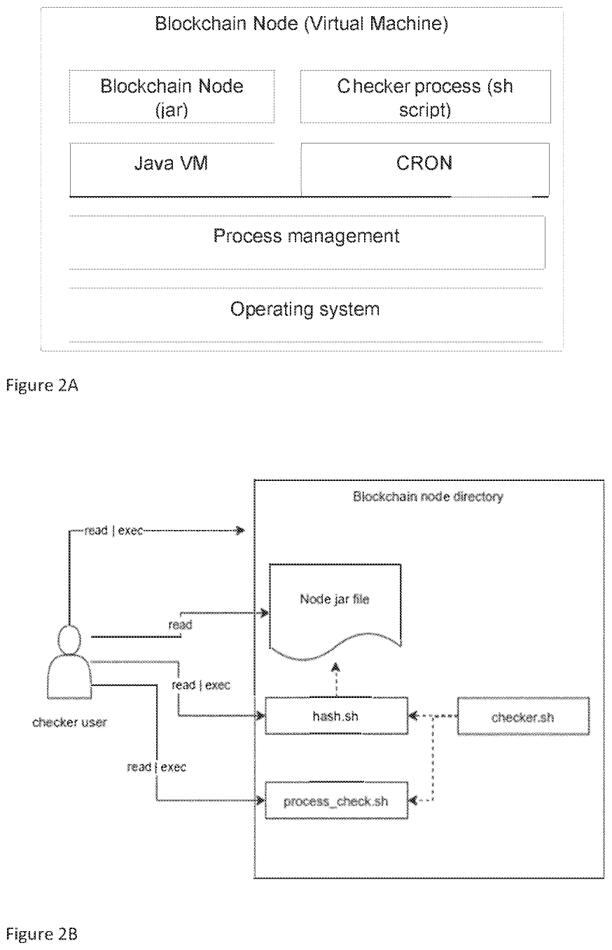

FIG. 2A shows an example of architecture of a blockchain node (either AN, EN or RN) according to the present disclosure. Each node of the network, AN, EN or RN has a dedicated software installation process.

This process requires the installation of a Virtual Machine, ‘VM’ and of a limited number of services running on the VM. These services include a checker process containing at least a “checker service” assuring that only authorized services are running on the VM and a “checker account” available to AN and RN as well as external nodes and PN, giving reading/executing rights on the pack of installed services. In this manner, any external node can freely check that a node is not corrupted. For each received transactions, at least one RN runs the checker service of the EN through its checking account to check the validity of the transaction. Of course, several RN may run the checker service of the EN. For a new generated block, the plurality of RN runs the checker service of the EN through its checking account to authenticate the block.

For the sub-layer architecture, as an example, each node contains a Java VM so that the blockchain node's Java application is deployed in executable jar mode and the jar of the application is stored in a directory with a predetermined pack of determined shell scripts, preferably four including a checker service, a process check service, a hash service and an extractor service. The node further contains a software utility CRON, which is a time-based job scheduler, that is used to run the checker process. An UNIX-like operating system, ‘OS’, such as Linux, and a process management running on the OS complete the sub-layers architecture.

FIG. 2B shows a preferred embodiment of the checker account of the blockchain node presented in FIG. 2A when running the checker process. Each node (AN, EN, RN) has a pack of predetermined services in the form of executable files including four services, namely the checker service (i.e. checker.sh script), a process check service (i.e. process_check.sh script), a hash service (i.e. hash.sh script) and an extractor service (i.e. extractor.sh script). The checker account is created by default in the folder where executable file(s) (e.g. jar file(s)) and the scripts are located.

The checker account has “read” rights on all the files, “execution” rights on all the scripts except the extraction script and no “write” rights. The checker account has no password, any person or node (e.g. RN, PN or ExN) with an Internet access can access and test the compliance of the Blockchain through the checker account of the EN and thus automatically ensure the veracity of the node taking over the block generation. The scripts belong to the root user, and no user will have the right to run in admin mode (sudoers) in the VM. The creator of the script is root so no one can modify them but checker users have the right to read them and execute them. In addition, they do not have the sudo privilege which gives them access to administrator level clearance.

The process checker service is used to retrieve the list of running services on the VM and ensure that only the services of the predetermined pack are running by validating that the list of running services correspond to the list of the pack of predetermined services.

The hash service contains instructions to hash the contents of the jar application and display the results.

The checker service runs periodically or on request from a node (CRON task) and ensures the following steps of (i) running the process checker service of the EN to retrieve a list of running services on its VM; and (ii) validating the running services when the list of running services and the list of the predetermined services concur. More specifically, the checker service executes the following sub-steps: (i) downloading a trusted source codes of the predetermined services stored in a trusted blockchain repository; (ii) compiling trusted source codes to obtain one or more trusted executable files; (iii) hashing, by the hash service, the one or more trusted executable files to obtain at least one trusted hash value and the one or more local executable files to obtain at least one local hash value; and (iv) either validating the one or more local executable files when the one or more local hash value and the one or more trusted hash value concur, or sending to the AN, an EN compromised, ‘ENC’, signal when the one or more local hash value and the one or more trusted hash value do not concur.

In addition to the fact that checker service runs periodically, it is also run after the election and every transaction that arrives on the block. This ensures that a fake node is never given a hand.

Preferably the checker service is coded as a very simple program of a few lines of code so as to check that the hash of the source of the current services are identical to the hash of the latest available version of such services.

### Example of Checker Service Code

```
#!/bin/bash
  export signature=‘md5sum tdxbc/knight.jar‘
  export LOCAL_SIG=${signature%% *}
    mkdir temp_src
    cd temp_src
    git clone <repository_url_here>
    cd <repository_name>
    mvn clean install
    export signature=‘md5sum
    <repository_name>/target/knight_1.0.0.jar‘
    export DIST_SIG=${signature%% *}
  if [ ″$DIST_SIG″ = ″$LOCAL_SIG″ ]; then
    echo ″0″ # All is good
  else
    echo ″1″ # Signatures are not equal
end
```

The extractor service allows to recover all the records of this Blockchain by bypassing the executable file(s). It consists of the commands needed to connect to the node's embedded database. Its purpose is to ensure that records can be externally isolated before and after a node is declared compromised. In the event that a node is detected to be compromised, the extractor service is used to retrieve the valid part of the block, while the administration node organizes a new election process and transmits these transactions as the starting node.

### Method for Consensus in a Blockchain

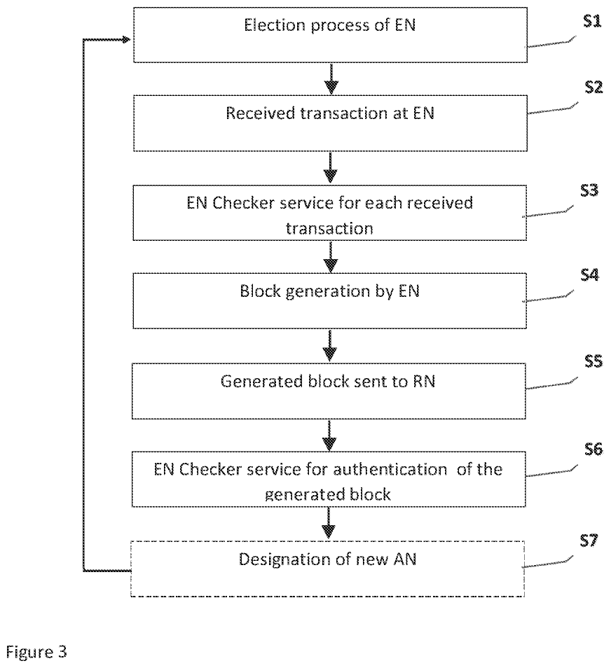

FIG. 3 shows a diagram of a consensus method according to one embodiment of the present disclosure from the EN point of view. The blockchain includes a distributed network with multiple nodes among which one administrative node, ‘AN’, one elected node, ‘EN’, and a plurality of regular nodes, ‘RN’, each of the AN, EN and RN having a virtual machine, ‘VM’, a checker service running on the VM and a checker account available to other nodes with reading and/or executing rights on the checker service; and provider nodes, ‘PN’, providing transactions to the blockchain.

The consensus method includes the following steps. An electing step (S1) executed by the AN to designate an EN amongst the plurality of RN. A receiving step (S2) executed by the EN receiving transactions from different PNs. A running step (S3) of the checker service of the EN through its checking account for each received transaction. A generating step (S4) executed by the EN, of a block containing the checked transactions. This generating step may be performed in several ways such as for example by sequentially adding all received and checked transactions to the block in generation. A sending step (S5) executed by the EN, of the generated block to the plurality of RN. And another running step (S6) of the checker service of the EN through its checker account for authenticating the generated block. In order to ensure continuity in the block generation, the method preferably further includes a designating step (S7) during which the EN is designated as the new AN and then looping to S1.

The running step of the checker service for each received transaction may be executed either by at least one RN amongst the plurality of RN or by any external node having access to the checker account of the EN. The running step of the checker service for the generated block is executed by the plurality of RN in order to ensure a high level of security for the generated block authentication.

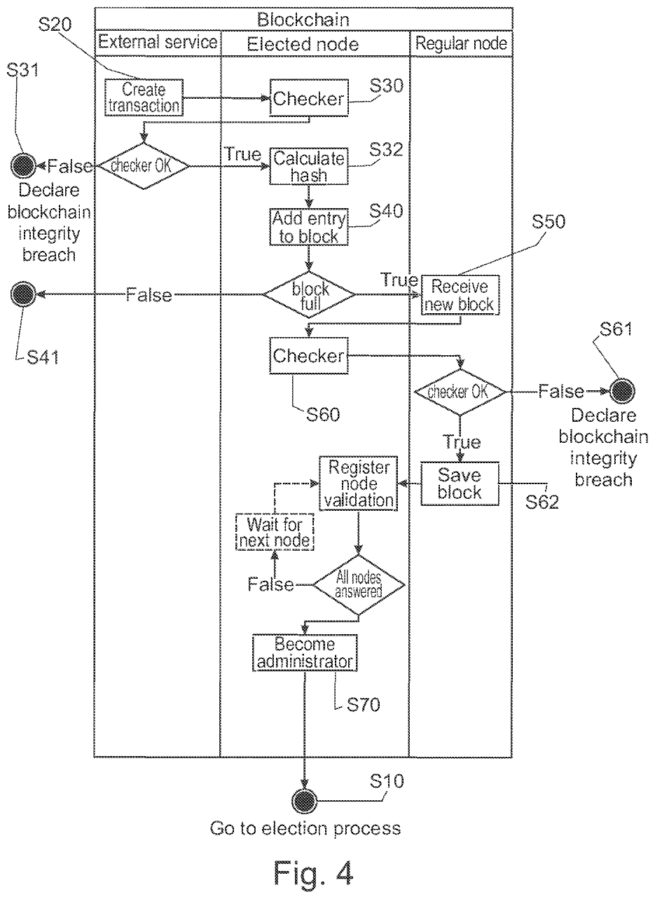

FIG. 4 shows a diagram of a consensus method according to another embodiment of the present disclosure seen from the whole network. The consensus method includes the following steps: (S10) electing an EN (not shown in FIG. 4) during which the AN will execute an election process based on election information received from the RN so as to elect one of the RN as the EN; (S20) creating a transaction coming from any external service such as a PN which is sent to the EN; (S30) running the checker service of the EN by an external service (ExN, PN or even RN) to check whether the received transaction is OK (i.e. reliable); (S31) if the outcome of the checker is “false”, i.e. the transaction is corrupted, then the consensus declares a blockchain integrity breach; (S32) if the outcome of the checker is “true”, i.e. the transaction is not corrupted, then the hash service of the EN is executed to then add the hashed transaction, so-called entry, to the block under construction; (S40) after adding a new entry to the block, it is checked whether the block under construction is full, i.e. the generated block is completed; (S41) if the block is not full, then the process goes back to S20; (S50) if the block is full, the newly generated block is sent to all the RN; (S60) each RN, which has received the new block, executes again the checker service of the EN; and (S61) if the checker is “false” then the consensus declares a blockchain integrity breach; (S62) if the checker is “true” then the block is saved by each RN until all RN validated the checker; (S70) the EN becomes the new AN and the process goes back to S10.

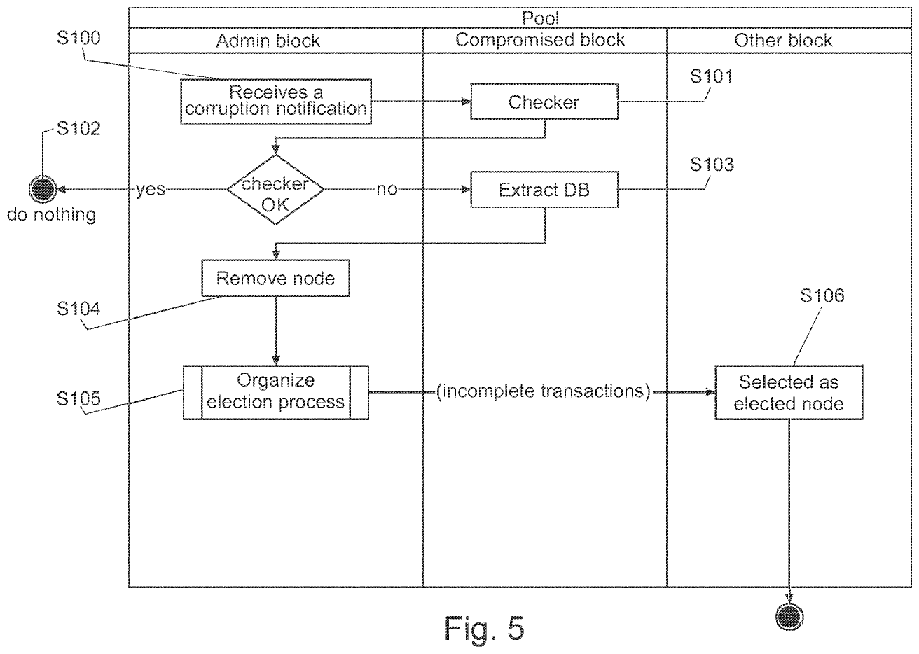

FIG. 5 shows a diagram in case of a corruption notification emitted during the consensus method. The blockchain integrity breach (S100) is sent to the AN. The AN executes the checker service of the EN (S101) to confirm that the EN is compromised. If the EN is not compromised, nothing is done by the AN (S102). If the EN is compromised the AN executes the extractor service of the EN and extracts the database so as retrieve the valid transactions (S103). Then the AN removes the compromised EN from the network (S104) and organizes a new election process (S105) without the removed node. When a new RN is selected as the new EN, the AN provides the retrieved incomplete transactions to the newly elected EN (S106). The process goes back then either to step S2 or S20.

Such consensus method offers several advantages among which solving the “Quis custodiet ipsos custodes” problem that seems to occur, namely the checker service checks the other services, however, which service checks the “checker”? This is in fact solved by the full transparency and utmost simplicity of the checker service that all nodes can access via the “checker” account, preventing any alteration of the checker service.

There is not a permanent “central node”. The Administrator Node or the Elected Node central positions are changing roles that are shared along time by the Regular Nodes.

Authentication is assured by services that can be activated at will by any one of the nodes of the system, and which is activated during key step of the Blockchain progressive building, in particular when adding a new transaction to a block and when adding a new block to the blockchain.

Only one node is working to construct the current block (the Elected Node), so there is no overconsumption of energy due to several nodes “mining” simultaneously as well as due to a high difficulty level.

### Election Process

In the above description, it has been referred to an election process several times.

According to one embodiment, the election process contains the steps of requesting, by the AN, election information from the plurality of RN; and electing, by the AN, the EN amongst the plurality of RN based on the requested election information. Such election information includes at least an elected occurrence number, ‘EON’, corresponding to the number of times an RN has already been elected.

In order to further strengthen the security of the blockchain, the election process is preferably based on a non-deterministic election algorithm using at least one random number to determine the EN to prevent other nodes or external devices anticipating which node will be successfully elected.

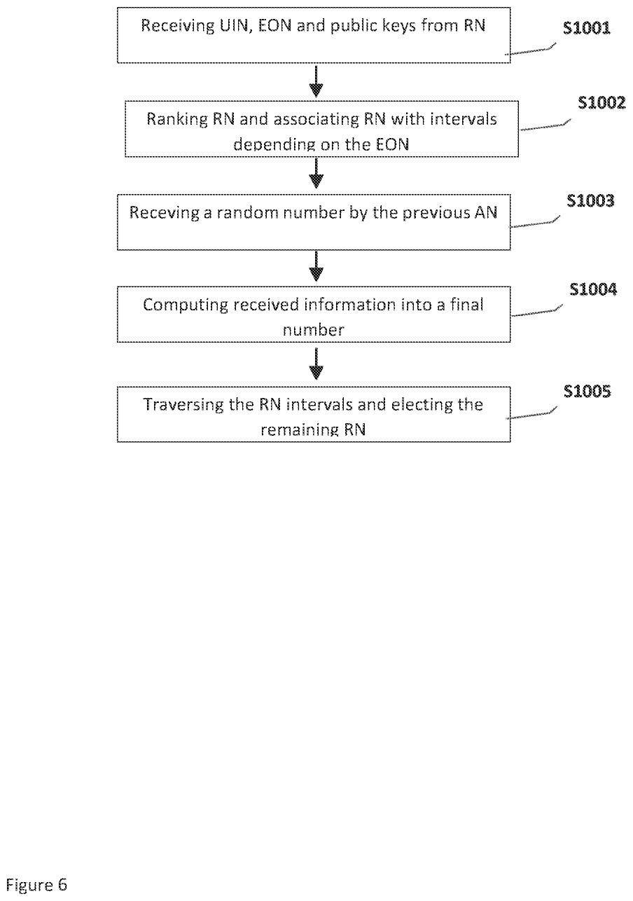

FIG. 6 shows an example diagram of an election process according to the present disclosure. In this example, each AN, EN and RN node is identified by a unique identification number, ‘UIN’, its EON and a set of public/private keys. The election process from the AN point of view comprises the steps of: (S1001) providing, by each RN, its UIN, its EON and its public key to the AN; (S1002) ranking, by the AN, the RN by their EON and associating each RN with an interval depending on the EON; (S1003) receiving, by the AN, a random number from the previous AN; (S1004) computing, by the AN, a function of the UIN and the EON, hashing the computed function result, encrypting the hashed function result with the AN private key, computing a function of the encrypted function result and the provided random number to get a final number; (S1005) traversing the RN intervals with this final number and progressively eliminating the corresponding RN it comes across, until only one RN remains which becomes the EN.

It is of course understood that obvious improvements and/or modifications for one skilled in the art may be implemented, still being under the scope of the invention as it is defined by the appended claims.

1. A method for consensus in a blockchain including a distributed network with multiple nodes among which
one administrative node, ‘AN’, one elected node, ‘EN’, and a plurality of regular nodes, ‘RN’, each of the AN, EN and RN having a virtual machine, ‘VM’, a checker service running on the VM and a checker account available to other nodes with reading and/or executing rights on the checker service; and
provider nodes, ‘PN’, providing transactions to the blockchain, the method includes the steps of:
electing, by the AN, the EN amongst the plurality of RN
receiving, by the EN, transactions from PN;
running the checker service of the EN through its checking account for each received transaction;
generating, by the EN, a block containing the checked transactions;
sending, by the EN, the generated block to the plurality of RN;
running the checker service of the EN through its checking account for the generated block to authenticate it.

2. A method for consensus in a blockchain according to claim 1, wherein the running step of the checker service for each received transaction is performed by at least one RN amongst the plurality of RN or any external node, ‘ExN’, and wherein the running step of the checker service for the generated block is performed by the plurality of RN.

3. A method for consensus in a blockchain according to claim 1, wherein each AN, EN, RN node further has predetermined services including the checker service and at least a process check service, all predetermined services running on the VM; and wherein the running steps of the checker service comprises the sub-steps of:
running the process checker service of the EN to retrieve a list of running services on its VM; and
validating the running services when the list of running services and the list of the predetermined services concur.

4. A method for consensus in a blockchain according to claim 3, wherein each AN, EN, RN node has one or more local executable files of the predetermined services which further includes a hash service, and wherein the running steps of the checker service further comprises the sub-steps of:
downloading a trusted source codes of the predetermined services stored in a trusted blockchain repository;
compiling trusted source codes to obtain one or more trusted executable files; and
hashing, by the hash service, the one or more trusted executable files to obtain at least one trusted hash value;
hashing, by the hash service, the one or more local executable files to obtain at least one local hash value; and
validating the one or more local executable files when the one or more local hash value and the one or more trusted hash value concur; or
sending to the AN, an EN compromised, ‘ENC’, signal when the one or more local hash value and the one or more trusted hash value do not concur.

5. A method for consensus in a blockchain according to claim 4, wherein the predetermined services further includes an extractor service, and wherein, when the AN receives an ENC signal, the running step further includes the sub-steps of:
using, by the AN, the checker service of the EN to confirm the ENC signal; and in case of a confirmed ENC signal:
using, by the AN, the extractor service of the compromised EN to retrieve checked transactions;
disconnecting the compromised EN from the distributed network; and
launching a new electing step.

6. A method for consensus in a blockchain according to claim 1, wherein the generating step of a block is performed upon detection of a predetermined condition, said predetermined condition being:
when a predetermined number of transactions have been checked; or
when a predetermined interval of time has elapsed since the electing step.

7. A method for consensus in a blockchain according to any of the preceding claims claim 1, wherein after authentication of the generated block, the method further comprises the step of:
designating the EN as the new AN before looping to a new electing step.

8. A method for consensus in a blockchain according to claim 1, wherein a running step of the checker service is further executed at regular time intervals.

9. A method for consensus in a blockchain according to claim 1, wherein a running step of the checker service is further executed just after the electing step by the AN to check that the EN is not corrupted.

10. A method for consensus in a blockchain according to claim 1, wherein the AN processes a new electing step whenever the EN is no longer available in the distributed network.

11. A method for consensus in a blockchain according to claim 1, wherein the electing step includes the sub-steps of:
requesting, by the AN, election information from the plurality of RN;
electing, by the AN, the EN amongst the plurality of RN based on the requested election information.

12. A method for consensus in a blockchain according to claim 11, wherein the election information includes at least an elected occurrence number, ‘EON’, corresponding to the number of times an RN has already been elected.

13. A method for consensus in a blockchain according to claim 12, wherein the election step is based on a non-deterministic election algorithm using at least one random number to determine the EN.

14. A method for consensus in a blockchain according to claim 13, wherein each AN, EN and RN node is identified by a unique identification number, ‘UIN’, its EON and a set of public/private keys and wherein the electing step comprises at least the sub-steps consisting of:
providing, by each RN, its UIN, its EON, its public key to the AN;
ranking, by the AN, the RN by their EON and associating each RN with an interval depending on the EON;
receiving, by the AN, a random number from the previous AN;
computing, by the AN, a function of the UIN and the EON, hashing the computed function result, encrypting the hashed function result with the AN private key, computing a function of the encrypted function result and the provided random number to get a final number;
traversing the RN intervals with this final number and progressively eliminating the corresponding RN it comes across, until only one RN remains which becomes the EN.

15. A method for consensus in a blockchain according to claim 1, wherein the blockchain consensus is a distributed ledger technology, ‘DLT’, containing shared data referred as transactions and wherein shared data are specific ID type data and wherein the method further comprises the step of:
authenticating upon request, the specific ID type data by a trusted third party via a smart contract.

16. A blockchain distributed network with multiple nodes comprising:
one administrative node, ‘AN’, one elected node, ‘EN’, and a plurality of regular nodes, ‘RN’, each of the AN, EN and RN having a virtual machine, ‘VM’, a checker service running on the VM and a checker account available to other nodes with reading and/or executing rights on the checker service; and provider nodes, ‘PN’, providing transactions to the blockchain distributed network; and wherein
a blockchain consensus method according to claim 1 is applied to the blockchain distributed network.

17. An electronic device comprising a processor and a memory wherein the memory is used to store the source code of the predetermined services and the processor is configured to host the virtual machine calling the source code stored in the memory to execute the method according to claim 1.

18. A computer-readable storage medium wherein instructions are stored in the computer-readable storage medium and when the instructions are run on a computer, the computer executes the method according to claim 1.
